(19) United States
(12) Patent Application Publication
(10) Pub. No.: US 2011/0302511 A1
(43) Pub. Date: Dec. 8, 2011

(54) METHOD FOR PROVIDING AN OPERATING MENU FOR A FIELD DEVICE OF PROCESS AUTOMATION TECHNOLOGY

(75) Inventors: Alain Chomik, Pulversheim (FR); Udo Fuchs, Waldshut-Tiengen (DE); Pierre Harnist, Bartenheim (FR)

(73) Assignee: Endress + Hauser Flowtec AG, Reinach (CH)

(21) Appl. No.: 13/115,240

(22) Filed: May 25, 2011

Related U.S. Application Data
(60) Provisional application No. 61/344,159, filed on Jun. 2, 2010.

(30) Foreign Application Priority Data
Jun. 2, 2010 (DE) DE10 2010029655.4

(51) Int. Cl. G06F 3/048

(52) U.S. Cl. 715/760

(57) ABSTRACT

A method for providing an operating menu (OM) for a field device (FD) of process automation technology, wherein the operating menu (OM) is displayed on a display unit of a servicing device (SD) remote from the field device (FD) by means of a web browser (WB). Settings of the field device (FD) are editable via the operating menu (OM); wherein a number of different operating menus (OM) are available by means of a web server (WS), especially a web server (WS) integrated in the field device (FD); and wherein one of the available operating menus (OM) is selected, especially by a user, via the web browser (WB).

### CROSS-REFERENCE TO RELATED APPLICATION

This application is a nonprovisional claiming the benefit of U.S. Provisional Application No. 61/344,159, which was filed on Jun. 2, 2010.

### TECHNICAL FIELD

The invention relates to a method for providing an operating menu for a field device of process automation technology, wherein the operating menu is displayed by means of a web browser on a display unit of a servicing device remote from the field device, and wherein the settings of the field device are editable via the operating menu. The invention additionally relates to a corresponding apparatus and to a computer program product.

### BACKGROUND DISCUSSION

Often, the case arises in process automation technology that a field device must be serviced or tuned from a remote, control station. Such a situation can arise e.g. when the field device has no on site display unit, or because the user is not located on site in the plant.

Consequently, different methods for enabling servicing of the field device under such circumstances have become known in the state of the art.

Obtaining information from a field device or adjusting the settings of the field device can occur, for example, by means of a servicing device. Such a servicing device includes a display unit, on which an operating menu is presented. Via the operating menu, the settings of the field device can be selected or information obtained from the field device. As a rule, operating menus are structured hierarchically in order to facilitate the user's finding the desired information. Especially for changing the settings of the field device, a user must call up individual menu levels via the menu navigation of the operating menu until the desired menu point is presented on the display unit of the servicing device.

For example, via corresponding operating elements of the servicing device, values can simply be selected from the default values provided by the manufacturer, or user specific inputs can be activated. The operating menu serves essentially for the call up and presentation of field device specific information as well as for changing device specific parameters. A large number of such field devices are available from the firm, Endress+Hauser. Problematic in the case of these field devices is that the on-site display units only have a limited resolution and thereby also the information presented is very limited. As a rule, operating menus are structured into tasks or subtasks, which the user performs, for example, at start up of the field device. The tasks are combined in windows (screens), which are presented on the display unit. For subtasks, the window, in given cases, must be further divided until the subtask fits in its own window. The information presented in a window, such as names of parameters and their associated values are more or less suitably placed on the display unit. To move from one window to another window, which is also referred to as navigating, the user must actuate different interaction elements (for example: mouse, scrollbar.) New windows are opened and displayed corresponding to the data stored in the field device and/or the servicing device. Frequently, the windows differ significantly in format, which is very disturbing to the user. The user must first get used to each new window. In this way, the user cannot concentrate on the actual task, the accessing of information and changing of parameter values. In the case of hierarchically structured operating menus having a plurality of nested windows, which, in each case, correspond to a certain level in the operating menu, orientation for the user is most often very difficult. Frequently, the user no longer knows the current level in the operating menu. In order to move from one window to another, the user must find or actuate the corresponding interaction elements. Often the interaction elements are located at different locations on the display unit, which makes navigating within the operating menu significantly difficult.

Frequently, it is also unclear to the user whether the desired information is to be found in a lower level or in a higher level of the operating menu. This is increasingly the case when the user is not acquainted with the operating menu or its structure. The search is then characterized by a “wild” jumping back and forth between individual menu levels. In general, orientation for the user within an unknown operating menu is not simple. Thus, finding specific information, i.e. navigating the operating menu, can be very complicated. Since in the case of field devices safety relevant settings must also frequently be performed, wrong inputs can be caused by user unfriendly, complicatedly embodied, operating menus.

Another problem, which occurs especially in the case of bus fed field devices, is that the energy available in the field device is limited. Thus, limited energy is available for the display unit, for the presentation as well as for the navigation of the operating menu. If the servicing of a field device occurs via an external servicing device, a laptop, for example, then these problems do not occur, since the screens of laptops usually possess a sufficient resolution to represent an operating menu well arranged and clearly and, in such a case, as a rule, sufficient energy is also available. A system for navigating in a hierarchical menu is known from WO03/1049977. This system is suitable for laptops, for example, but not for display units with low resolution.

### SUMMARY OF THE INVENTION

Therefore, an object of the invention is to provide to a user with an operating menu which is known to the user, and which especially enables a simple and user friendly menu navigation.

According to the invention, the object is achieved by a method, a computer program product and an apparatus.

As regards the method, the object is achieved by the features that a plurality of different operating menus are made available by means of a web server, especially a web server integrated in the field device, and that one of the available operating menus is selected via a web browser, especially by a user.

Via the web server, integrated in the field device for example, different operating menus can be made available. For this purpose, the web browser can be executed and/or stored in the servicing device. Alternatively, the web server can be provided, for example, at an access point, for example, a Fieldgate, in a plant of process automation technology. The field device can then communicate in turn with this access point, via a bus system for example. The different operating menus or each of the different operating menus can then be accessed from the web server by means of the web browser. Through the web browser, the operating menu accessed also can be displayed on the display unit of the servicing device, which is remote from the field device, i.e. externally, especially in the web browser. In such a case, the servicing device need not be part of the field device, but instead can just be connected to the field device via a communication connection.

For transmitting data between the web server and the web browser, standardized transmission protocols such as for example, HTTP, HTTPS and network protocols such as IP and TCP can be used. As mentioned above, the web server can be in the field device and the web browser can be in the servicing device so that, for example, the standardized transmission protocols mentioned for the transmission of data between the field device and servicing device are used.

The web server can essentially be software. For example, in the case in which the web server is integrated, especially embedded, in the field device, this software can be executed by a corresponding computer unit likewise provided in the field device. The data needed for the representation of the operating menu by the web browser can, for example, then be sent via the Internet or an intranet to the servicing device, and, respectively, to the web browser contained therein, by means of the web server.

The present invention enables a user, for example, to select a trusted or an intuitively accessible presentation of the operating menu, in order to service the field device. The operating menu can, for example, be at least partially an arrangement of editable settings and a presentation of these editable settings, which can be rendered on the display unit. As already mentioned above, the information and settings can be arranged on different menu levels of the operating menu. Accessible information or performable settings can thus in each case be structured hierarchically differently, depending on the selected operating menu, and thus make use of a different structure.

In order to select one of the operating menus, the web browser can make use of a corresponding option, for example, in the form of an operating menu entry of the web browser, which, for example, can be selected by a user. This input is then sent to the web server, which then makes a corresponding operating menu available. The operating menu can then be presented by the web browser in the form of a web page. The web page can be created as an HTML document for example. This HTML document can be transmitted by the web server to the web browser. Additionally, the web page can be created by application of a Cascading Style Sheet file CSS and a JavaScript file JS. Also, the CSS file and/or the JavaScript file can be sent by the web server to the web browser for this purpose. Alternatively, a (new) CSS file and/or a (new) JavaScript file can simply be sent to the web browser after a new operating menu is selected. The HTML document stored or previously transferred in the web browser is then executed with the new CSS file and/or the new JavaScript file for producing the web page. In such a case, communication between the web browser and the web server can also occur at least sectionally via the Internet or an intranet.

In one embodiment, the web server and the web browser are directly connected to the Internet/intranet and to one another via the Internet/intranet.

In an embodiment of the method, the available operating menus are stored in the form of at least one operating menu description file in the field device or in the web server of the field device, wherein one of the operating menu description files is selected via the web browser, and wherein the operating menu selected from the operating menu description files is provided for the web browser in the form of an operating menu description language by means of the web server integrated in the field device. However, a number of operating menu description files, which can be selected by means of the web browser, can also be stored on the web server. In such a case, a number of operating menu description files, which serve for the representation of the operating menu, can also be used for the creation of a web page. The operating menu description file selected via the web browser can be transmitted to the web browser after being called up. The corresponding operating menu description file can be transmitted also automatically by the web browser, for example, in the case of the selection of a determined operating menu by a user. The operating menu description file can be, for example, the CSS file and/or the JavaScript file already mentioned. The operating menu description file can also be a graphic or a picture. Such graphics or pictures can contribute to symbolizing functions in the operating menu and thus also to the better serviceability of the operating menu and thereby the field device. The operating menu description file can also be one or a number of the following files: an HTML document, a CSS file, a JS file, a picture or a graphic. The HTML document applied for the representation of the operating menu and executed in the web browser can then use the currently selected operating menu description file for the representation of the operating menu. For example, a reference to the corresponding operating menu description file can be stored in the HTML document.

In an additional embodiment of the method, the available operating menus differ from one another at least through each having a different operating menu structure and/or each having a different user interface. As already mentioned, an operating menu can essentially be an operating menu structure, through which the operating menu is, for example, structured hierarchically, and a corresponding presentation of the operating menu on the display unit, the so-called the operating menu interface. Different operating menus can then differ as regards their operating menu structure and/or operating menu interface, i.e. their presentation. In such a case, the operating menu structure can be set, for example, essentially from a set of links to available parameters of a field device and/or process relevant information concerning a field device.

In an additional embodiment of the method, an operating menu interface belonging to an available operating menu is likewise made available in the form of an operating menu description language by the web server integrated in the field device. The operating menu description language can be, for example, CSS, JavaScript and/or HTML.

In an additional embodiment of the method, the field device, especially the web server integrated in the field device, contains an operating menu generating system and the corresponding operating menu, in the form of an operating menu description language, is provided by the operating menu generating system using the selected operating menu description file. Alternatively, the operating menu generating system can also be in the servicing device and/or especially integrated in the web browser and/or executed by the web browser.

In an additional embodiment of the method, the operating menu generating system comprises essentially an operating menu description file, which includes the representation of the operating menu, and an operating menu production program for the creation of the operating menu description language from the operating menu description file.

In an additional embodiment of the method, the selected operating menu and/or the corresponding user interface is produced for the time of operation of the field device (i.e. during operation) in the form of the operating menu description language and is provided by the web server. The selected operating menu can then be presented by the web browser, for example, also during the time of operation of the field device and/or the time of operation of the servicing device.

In an additional embodiment of the method, the representation of the user interface occurs on the web page displayed by means of the web browser. The user interface of the operating menu can be presented on the display unit by means of the web browser, and in such a case the display unit can be part of the servicing device. The servicing device can be a PC or, also a PDA, mobile telephone, laptop or also a so called handheld.

In an additional embodiment of the method, the operating menu is selected from a selection menu of the web browser. The selection menu lists the available operating menus.

In an additional embodiment of the method, the plurality of different operating menus comprise the presentation on the on-site servicing unit of the field device, the Fieldcare presentation, PDM presentation, AMS presentation. The operating menus, which a user selects to service a field device, can be, for example, the operating menu on the on-site display unit of the field device. AMS of Emerson Process, PDM of Siemens, HART Hand Held Communicator of Emerson Process and PACTware are programs which serve for remote servicing of field devices and which have different operating menus.

The object, as regards the computer program product, is achieved by an executable program code. The program code is stored in a memory unit and is suitable for performing the method of at least one the preceding embodiments, when the program code is executed. In such a case, the memory unit in which the program code is stored can be located, for example, in the field device and/or in the servicing device.

As regards the apparatus, the object is achieved by means for editing the settings of a field device of process automation technology, for performing the method as claimed in one of the preceding embodiments.

### BRIEF DESCRIPTION OF THE DRAWINGS

The invention will now be explained in greater detail based on the appended drawing, the figures of which show as follows:

FIG. 1 is a representation of a Fieldcare operating menu in a web browser;

FIG. 2 is a representation of an operating menu of an on-site display unit in a web browser;

FIG. 3 is a schematic representation of a field device and a servicing device connected therewith according to an embodiment of the present invention; and

FIG. 4 is a schematic representation of a field device and a servicing device connected therewith according to an additional embodiment of the present invention.

### DETAILED DISCUSSION IN CONJUNCTION WITH THE DRAWINGS

FIG. 1 is a view of a web browser WB, here Internet Explorer, which is displaying an operating menu OM in the form of a web page P. In such a case, the web browser WB is executed by a servicing device SD and presented on the display unit of the servicing device SD. The servicing device SD can be located at a distance from the field device FD, thus externally, and can be connected to the field device FD via a communication connection COM. The field device FD, which is located for example, in a plant of process automation technology, can be parametered via the operating menu OM, e.g. for start-up. The settings of the field device FD can be edited and/or accessed via the operating menu OM. However, process relevant information can also be downloaded from the field device FD via the operating menu OM.

The operating menu OM illustrated in FIG. 1 is the operating menu OM of the remote adjustment program, Fieldcare, of the firm, Endress+Hauser.

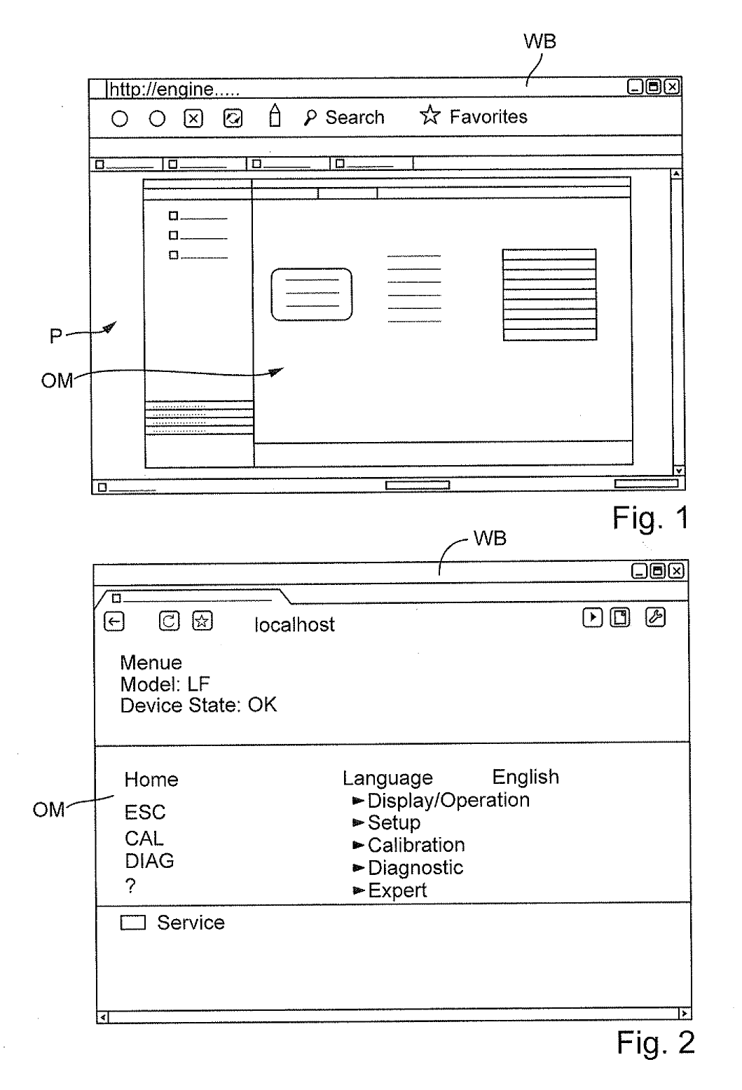

FIG. 2 is a view of another operating menu OM in the web browser WB. The operating menu OM shown in FIG. 2 is the operating menu OM as presented on-site, on a display unit of a field device FD, for example. Since the on-site display unit is often essentially more robustly equipped than the one of the servicing device SD and also does not have available the hardware resources available to a PC, the on-site operating menu OM of FIG. 2 is kept, for example, essentially simpler, as regards the graphics, than the Fieldcare style of operating menu OM shown in FIG. 1.

Nevertheless, for a user who is accustomed to interacting with the operating menu OM of the on-site display unit, it can be advantageous to use this operating menu OM of the on-site display unit also on the servicing device SD.

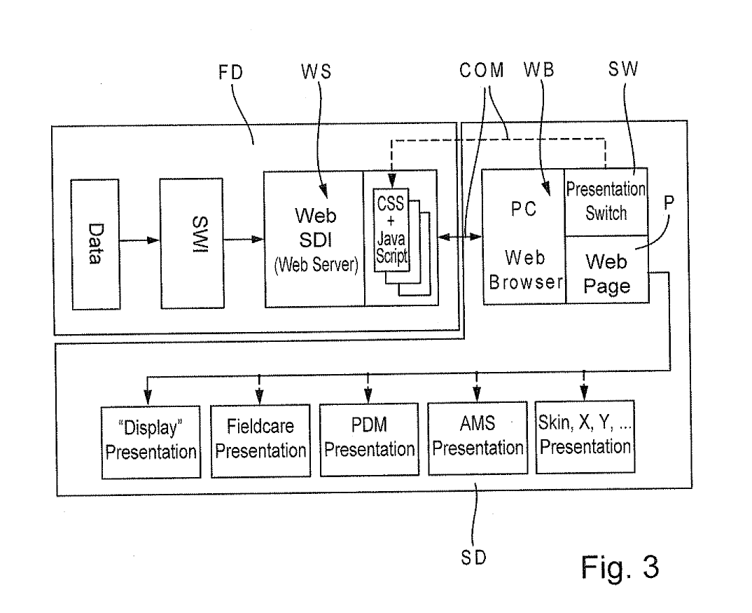

FIG. 3 shows a schematic representation of a field device FD and a servicing device SD according to the present invention.

On the one hand, the web server WS is provided in the field device FD, while on the other hand, the web browser WB is provided in the servicing device SD. Data, which is to be transmitted from the web server WS to the web browser WB of the servicing device SD, is made available by the field device FD. These data are forwarded via an interface, here a so-called Smart Web Interface SWI, within the field device FD to the web server WS. The data can be, for example, measured values, parameter values, etc.

The servicing device SD, here a PC or laptop, is connected to the web server WS of the field device FD via the communication connection COM, here the Internet. The servicing device SD has a web browser WB available, which has loaded an HTML document, which enables the presentation of an operating menu OM on the display unit of the servicing device SD. This HTML document can also be made available by the web server WS. Furthermore the web browser WB has a switch SW (“presentation switch”) available, via which the displayed operating menu OM or the presentation of the operating menu OM can be selected. The switch SW is, in such case, preferably integrated in the web browser WB by software. In this way, a user can choose between the on-site “display” presentation, the Fieldcare presentation, the PDM presentation or the AMS presentation. Additionally, the appearance of the operating menu OM can also likewise be selected by means of the switch SW and thus changed through the selection of various skins, i.e. presentations.

If an operating menu OM and, respectively, its presentation is selected via the switch of the web browser WB, then a corresponding report is sent to the web server WS (preferably via the communication connection COM). Thereupon an operating menu description file, CSS or JavaScript, which is written in an operating menu description language, is selected by the web server WS and transmitted to the web browser WB of the servicing device SD. The operating menu description file in the example of an embodiment shown in FIG. 3 is a Cascading Style Sheet file and a JavaScript file. The operating menu selected can be presented on the web page P. This is illustrated in FIG. 3 by the boxes with the labels “Display” presentation, Fieldcare presentation, PDM presentation, AMS presentation, and skin X, Y, . . . presentation.

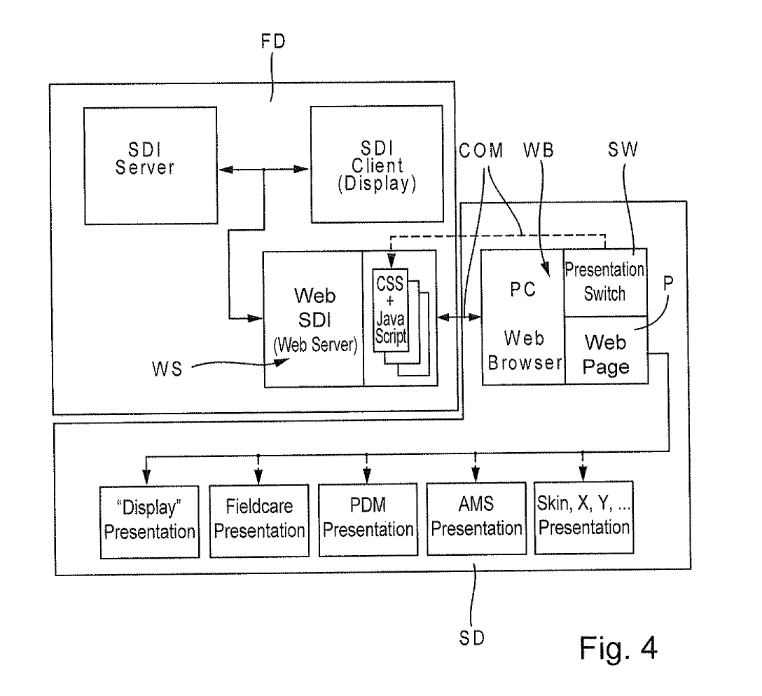

FIG. 4 shows a schematic presentation of a field device FD and a servicing device SD according to an additional embodiment of the present invention.

Here, the field device FD also includes different modules, especially software modules, i.e. SDI server, SDI client, Web SDI, through which the different functionalities of the field device FD are executed. SDI stands for Smart Display Interface. The data required by the respective SDI modules can be obtained, and, respectively, sent, from the SDI server. The Web SDI serves here as a web server WS and is connected to the web browser WB of the servicing device SD via a communication connection COM. The servicing device SD can be a PC, for example. The SDI client of the field device serves for operating the on-site display unit of the field device FD.

1. A method for providing an operating menu (OM) for a field device (FD) of process automation technology, comprising the steps of:
displaying the operating menu (OM) on a display unit of a servicing device (SD) remote from the field device (FD) by means of a web browser (WB);
editing the settings of the field device (FD) via the operating menu (OM);
wherein a plurality of different operating menus (OM) are available by means of a web server (WS), especially a web server (WS) integrated in the field device (FD); and
selecting one of the available operating menus (OM), especially by a user, via the web browser (WB).

2. The method as claimed in claim 1, further comprising the steps of:
the available operating menus (OM) in the field device (FD) in the form of operating menu description files (CSS, JavaScript);
one of the operating menu description files (CSS, JavaScript) is selected via the web browser (WB); and
providing the operating menu (OM) is provided by means of the integrated web server (WS) from the selected operating menu description file (CSS, JavaScript) to the web browser (WB) in the form of an operating menu description language (CSS, JavaScript).

3. The method as claimed in claim 1, wherein:
the available operating menus (OM) differ from one another at least through each having a different operating menu structure and/or each having a different user interface.

4. The method as claimed in claim 1, wherein:
a user interface belonging to an available operating menu (OM) is likewise made available in the form of an operating menu description language (HTML, CSS, JavaScript) by the web server (WS), especially a web server (WS) integrated in the field device (FD).

5. The method as claimed in claim 1, wherein:
the field device (FD), especially the web server (WS) integrated in the field device (FD), contains an operating menu generating system; and
the corresponding operating menu (OM) is provided by means of the operating menu generating system in the form of an operating menu description language (CSS, JavaScript) from the selected operating menu description file (CSS, JavaScript).

6. The method as claimed in claim 1, wherein:
the operating menu generating system is essentially an operating menu description file (CSS, JavaScript), which includes the presentation of the operating menu (OM), and an operating menu production program for the creation of the operating menu description language from the operating menu description file (CSS, JavaScript).

7. The method as claimed in claim 1, wherein:
the selected operating menu (OM) and/or the corresponding user interface are/is produced for the time of operation (i.e. during operation) of the field device (FD) in the form of the operating menu description language and are/is provided by the web server (WS).

8. The method as claimed in claim 1, wherein:
the presentation of the user interface occurs on a web page (P) displayed by means of the web browser (WB).

9. The method as claimed in claim 1, wherein:
the operating menu (OM) is selected from a selection menu (SW) of the web browser (WB);
and all available operating menus (OM) are listed in the selection menu (SW).

10. The method as claimed in claim 1, wherein:
the plurality of different operating menus (OM) comprise the presentation on the on-site servicing unit of the field device (FD), the Fieldcare presentation, the PDM presentation, and the AMS presentation.

11. The method as claimed in claim 1, wherein:
the remote servicing device (SD) is a PC.

12. A computer program product with executable program code, where the program code is stored in a memory unit and is suitable for performing the method as claimed in claim 1, when the program code is executed.

13. An apparatus (FD, SD) for editing settings of a field device (FD) of process automation technology for performing the method as claimed in claim 1.
